(19) United States
(12) Patent Application Publication
(10) Pub. No.: US 2015/0225306 A1
(43) Pub. Date: Aug. 13, 2015

(54) METHOD OF REMOVING AND CLEANING SOLID MATERIALS WITHIN OR CONTAMINATED BY ANIMAL MANURE

(71) Applicant: JAMES RODNEY DICKERSON, Homer, LA (US)

(72) Inventor: JAMES RODNEY DICKERSON, Homer, LA (US)

(21) Appl. No.: 14/621,763

(22) Filed: Feb. 13, 2015

Related U.S. Application Data
(60) Provisional application No. 61/939,469, filed on Feb. 13, 2014.

(51) Int. Cl. C05F 3/00

(52) U.S. Cl. CPC C05F 3/00

(57) ABSTRACT

A process for the production of a totally organic and natural soil enhancement liquid product, which includes waste byproduct from animal farm operations and common soil microbiology prepared and delivered in a carefully controlled process, which greatly increases plant health and growth, while simultaneously reducing the need to apply synthetic chemicals for nutrients, pests and disease, while cleaning the solids for recycling, composting or reuse in animal foods.

### CROSS REFERENCE TO RELATED APPLICATIONS

This application claims the benefit of the priority of U.S. Provisional Patent Application No. 61/939,469, filed Feb. 13, 2014,the contents of winch are incorporated herein by reference.

### FIELD OF THE INVENTION

The invention is directed to the field of animal husbandry and, in particular, to a method of removing and cleaning solid material contained within or contaminated by animal manure.

### BACKGROUND OF THE INVENTION

Animal manure waste usually contains indigestible solid materials and, depending upon the animal and where it is being confined, may also contaminate associated solids used, for example, as bedding in the case of horses, or litter in the case of chickens.

Traditional methods for dealing with these excretions from the animals being raised that accumulate in the confinement areas consist primarily of removing and transporting the materials to land areas and applying them directly to the soil. Alternatively, the materials may be gathered and microbiologically digested, such as composting, prior to land application to break down some of the components and provide some level of microbiological management, making the material easier for the soil to accept.

It is known in the industry that waste from animal farming operations can be used to enhance the growth rate and health of plants, from simple algae to trees, depending only upon the type of waste and the environment of the specific plant species. This waste contains leftover food not consumed by the animal, fecal matter (which contains microbiology), and metabolites from microbiology living within the waste. The principal drawbacks in using this waste for application: 1) inconsistent organic composition; 2) high variability of the indigenous microbiology, in both composition and population; and, 3) the high degree of susceptibility to runoff after soil application resulting in stream contamination. The inability to control these three variables is a barrier to widespread use of this sustainable byproduct.

While land application of the waste is known in the prior art, there is a large inconsistency in the waste quality and it may contain chemistry applied to the animals, which then simply adds to the lack of quality chain when the waste is used as soil enhancement material. In the vast majority of all cases of animal farming, the waste is of such a varied composition there is no substantial or sustainable consistent market value, so it becomes a waste product, which must be dealt with before being released into the environment.

What is needed in the industry is a method of processing a consistently nutrient rich liquid product from the traditional animal wastes that may be used as an easily applied and readily assimilable soil enhancement liquid, while rendering the remaining solids materials into a recyclable format, with or without added beneficial soil microbiology.

### SUMMARY OF THE INVENTION

Described herein is a process to overcome these barriers and produce a liquid soil enhancement material that is acceptably consistent in composition, both from organic and microbiological content. Additionally, while it is desirable to have a purely natural organic environment without any added artificial chemicals, this is not a limiting factor if the use of the liquid soil enhancement material does not preclude such added chemistry.

Yet still another objective of the invention is to disclose a method to convert, through purification, the nutrient rich water stream in such a way that it is suitable for use as a liquid soil enhancement base material.

Other objectives and further advantages and benefits associated with this invention will be apparent to those skilled in the art from the description, such as using the enzyme surfactin produced by genus Bacillus bacteria, such as B. Subtillis living in high concentrations, to wash manure contaminated solids, examples and claims, which follow.

### BRIEF DESCRIPTION OF THE DRAWINGS

FIG. 1 is a flow diagram of the process of the instant invention.

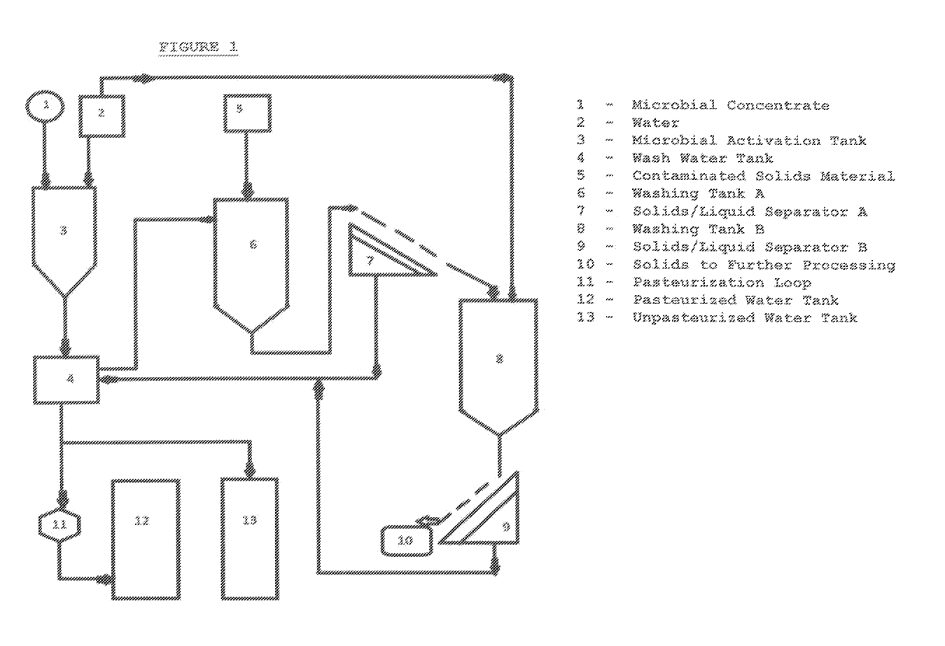

### DETAILED DESCRIPTION OF THE INVENTION

Detailed embodiments of the instant invention are disclosed herein, however, it is to be understood that the disclosed embodiment is merely exemplary of the invention, which may be embodied in various forms and is in no way intended to limit the invention, its application or uses. Therefore, specific composition ranges disclosed herein are not to be interpreted as limiting, but merely as a basis for the claims and as a representation basis for teaching one skilled in the art to variously employ the present invention in virtually any appropriately detailed composition. The embodiments of the invention may be practiced without the theoretical aspects presented. Moreover, the theoretical aspects are presented with the understanding that the Applicant does not seek to be bound by the theory presented.

It should be understood that numerous specific details, relationships, and methods are set forth to provide a full understanding of the invention. One having ordinary skill in the relevant art, however, will readily recognize that the invention can be practiced without one or more of the specific details or with other methods. The present invention is not limited by the illustrated ordering of acts or events, as some acts may occur in different orders and/or concurrently with other acts or events. Furthermore, not all illustrated acts or events are required to implement a methodology in accordance with the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Definitions

The terminology used herein is for the purpose of describing particular embodiments only and is not intended to be limiting of the invention. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

As used herein, the terms “comprising,” “comprise” or “comprised,” and variations thereof, in reference to defined or described elements of an item, composition, apparatus, method, process, system, etc. are meant to be inclusive or open ended, permitting additional elements, thereby indicating that the defined or described item, composition, apparatus, method, process, system, etc, includes those specified elements—or, as appropriate, equivalents thereof—and that other elements can be included and still fall within the scope/definition of the defined item, composition, apparatus, method, process, system, etc.

The term “about” or “approximately” means within an acceptable error range for the particular value as determined by one of ordinary skill in the art, which will depend in part on how the value is measured or determined, i.e., the limitations of the measurement system. For example, “about” can mean within 1 or more than 1 standard deviation, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Where particular values are described in the application and claims, unless otherwise stated the term “about” meaning within an acceptable error range for the particular value should be assumed.

“Optional” or “optionally” means that the subsequently described event or circumstance can or cannot occur, and that the description includes instances where the event or circumstance occurs and instances where it does not.

“Soil” is meant to include any medium used in the germination, growth, maintenance and general health of flora. For example, the “soil” enhancement platform materials embodied herein are added to, or in place of the mineral nutrient solutions.

“Material”, “platform material”, “soil enhancement material”, “soil enhancement platform material”, are used interchangeably herein and applies to the material produced by the systems and methods herein. The materials can be solid, semi-solid, liquid or any form necessary for the production, processing, storage, distribution, delivery to consumers and field application, for example, to crops, turfs, etc. The material can be used as a platform for addition of any one or more, for example: nutrients, vitamins, minerals, essential and non-essential amino acids, etc. Accordingly, the composition of the platform material can be varied based on the desired end use.

The process consists of three parts. The first part is the animal in a farm or other confining environment, which, in the present embodiment, produces manure that results in an undetermined, yet measurable and somewhat consistent volume, together with associated solid matter such as unconsumed food, animal bedding materials, such as straw or wood shavings or chips, which is collected and removed on a predetermined basis.

In the present embodiment, the animals are fed a fairly consistent formulation depending upon the particular animal species and circumstances of confinement, therefore, produce a fairly consistent composition and volume of manure, which, in turn, is comprised of somewhat consistent indigenous fecal microbiology and undigested food solids.

The circumstances of the confinement will also dictate what, if any, associated solid materials not contained within the manure that may be present. For example, in the case of horses, it is common for wood shavings to be used as bedding materials in the stables, which in turn becomes contaminated with both manure and urine and are removed and replaced when removing the manure. In the case of chickens, there is litter, which may be wood shavings, sawdust or other materials, and likewise contaminated. In every instance, these contaminated waste solid materials are collected and transported to the location of the second process part.

The second process part consists of Washing Tank 6, wherein the entire waste volume, manure and associated solids 5, are added and subjected to water from Wash Water Tank 4 that is prepared to contain a high concentration of microbiology from Microbial Activation Tank 3 of select soil bacteria from concentrate 1, preferably, but not limited to, bacteria from genus Bacillus in general, and more particularly, bacteria that are non-pathogenic. The formulation and concentration of said microbe-laden water will depend upon both the source waste material and the destination of the water after separation from the washed solids.

Waste 5, and Microbe laden water from Wash Water Tank 4, is subjected to vigorous mixing in Washing Tank 6 to cause the manure to break apart and to leave the solids. Two or more tanks are employed in a counter-current flow fashion wherein the contents of Washing Tank A 6 are sent to Solids/Liquid Separator A 7 where the solids are removed and sent to a subsequent Washing Tank B 8 where additional microbial laden water, or plain water, is introduced and additional vigorous mixing performed. The solids may be, once again, removed in Solids/Liquid Separator B 9 and sent to a subsequent tank for additional washing or sent to drying. The water from the downstream washing tanks is moved upstream to the prior tanks as make up water. Water is removed from the first Wash Water Tank 4 based upon control parameters indicating consistent composition and sent to Pasteurization Loop 11, or storage for final blending and shipment.

The third part of the process consists of drying and conditioning the solids, which may either be reused as bedding or litter, composted or other beneficial use, such as animal food. Because the solids are coated with beneficial soil bacteria, they serve the dual purpose of also benefiting the animals if ingested, as they are considered probiotic in nature; and counter harmful bacteria, including those that produce ammonia, for example, in chicken houses.

Unique to this process are the additional steps, which may be applied if desired, of controlling the indigenous microbiology and may be necessary to produce a viable, sustainable product. The first step involves the control of the indigenous microbiology, while, in most cases, is harmless to the environment and may, in some cases, be beneficial, it is, nevertheless, inconsistent on both counts. In order to remove the indigenous bacteria from consideration, the wash water held is sent to a pasteurization process where it then is subjected to an extreme pasteurization by flash heating up to or above 185 degrees Fahrenheit (F) for one minute or more within the purification system. In the case of milk, for example, pasteurization does not kill all the microbiology, but suppresses the viable population because it is done at lower temperatures and holding times. It is well known that higher temperatures and hold times causes the deterioration of the proteins and affects taste and flavor in milk. In the case of the liquid soil enhancement material, there is no real concern for taste or flavor, so some degradation of the proteins is very acceptable and even desirable. The higher temperatures effectively kill all indigenous microbiology, rendering the liquid an ideal environment to grow a specific microbiology to a desired concentration and thereby transform the liquid into a controlled soil enhancement substance, which may be applied in a repeatable, specific manner to achieve desired results.

The combined mixture is flash heated to a temperature between 145-185 degrees Fahrenheit and held for a period of time between 20-60 seconds before being immediately cooled in heat recovery equipment within the purification system to a temperature below 100 degrees Fahrenheit where it is then stored in liquid tanks. The present invention may include the addition of a formula of naturally occurring bacteria from the genus Bacillus selected specifically for their ability to work symbiotically with each other and the particular plants where it will be applied to the pasteurized mixture. The pasteurized mixture is held for a period of time to allow the added formula to achieve a desired concentration at or before actual application such that the microbial formulation is at appropriate concentration and in vegetative state so it will work immediately upon application. The specific volume and microbial concentration of the formula added to the sterilized mixture is determined by consulting a table, pertaining to the predetermined growth rates of these formula in sterilized mixtures tested to achieve a desired concentration of the specific microbial formulation mentioned.

It is well known that adding certain microbiology to soil is beneficial in many ways and this is especially true for microbiology commonly found in soil such as that from genus Bacillus. Many companies offer various formulations of both vegetative and spore state microbes, as well as fungi, in a wide variety of concentrations for dilution and application to soil. Indeed some companies even offer packets of formula, together with nutrients, to be added to water in a tank and thereby allowed to grow to some concentration over a prescribed period of time prior to application, either directly or indirectly via dilution with water in either a mobile sprayer or fixed irrigation process. The limitations of diluting fixed concentrations is a combination of high cost for those containing only spores, as well as shelf life for those containing vegetative microbial and fungal species, either alone or in combination with spores.

The limitations on those offerings claiming to grow bacteria from prepackaged formula containing food and nutrients are similar. Overall, this restricts that application rate (number of microbes per unit surface area) in general, and the bacteria quickly deplete the available food and nutrients. Additionally, if there are insufficient food and nutrients in the soil to sustain the added microbiology, the added microbiology does not have the opportunity to thrive in the new environment. It is well known in the literature that moving microbiology from one environment to another can create what is termed a “shock” condition where reproduction is hindered or suspended. Therefore, it is extremely difficult to apply a sufficient population to the soil to truly change the microbiological makeup and, of equal importance, sustain that change to the benefit of the plants.

While a detailed embodiment of the instant invention is disclosed herein, it is to be understood that the disclosed embodiments are merely exemplary of the invention, which may be embodied in various forms and include most any radius form. Therefore, specific functional and structural details disclosed herein are not to be interpreted as limiting, but merely as a basis for the claims and as a representation basis for teaching one skilled in the art to variously employ the present invention in virtually any appropriately detailed structure.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art, which are encompassed within the spirit of the invention and are defined by the scope of the appended claims. Although the invention has been described in connection with specific preferred embodiments, it should be understood that the invention, as claimed, should not be unduly limited to such specific embodiments. Indeed, various modifications of the described modes for carrying out the invention, which are obvious to those skilled in the art, are intended to be within the scope of the following claims.

What is claimed is:

1. A method of producing a natural liquid soil enhancement material comprising the steps of:
placing animal manure and associated solids into a first washing tank containing a microbially enhanced fluid;
vigorously mixing the manure and associated solids with the microbially enhanced fluid such that the manure and associated solids separate from one another to establish a manure slurry;
passing said manure slurry from said washing tank through a solids/liquid separation device for removal of suspended particulate matter;
directing the particulate matter to a second washing tank and directing the separated liquid after solids/liquid separation back to the first washing tank;
adding a predetermined composition of the microbially enhanced fluid to second washing tank with the separated particulate matter and vigorously mix and wash the particulate matter before passing the entire mixture through the solids/liquid separation device for removal of suspended solids and sending the separated solids to drying or further conditioning;
moving the liquid after solids/liquid separation back into first wash water tank and sampling of the first wash water tank liquid for COD, Total Nitrogen, Total Phosphorous, Total Potassium and presence of pathogens;
adjusting the first wash water tank to an acceptable value by blending additional fluid; removing a portion of wash water tank fluid and purifying said removed portion of wash water tank fluid by pasteurization at high temperatures and place into a container for shipping.

2. The method of claim 1 wherein said solid/liquids separator separates and removes a biomass of solids, semisolids and/or some dissolved solids from the fluid.

3. The method of claim 1, including the step of purifying wherein said wash water tank fluid is removed and is flash heated to between 145-185 degrees Fahrenheit (F) for less than minute before being immediately cooled in heat recovery unit to less than 100 degrees Fahrenheit.

4. The method of claim 1, further comprising: sampling of the wash water tank fluid for COD, Total Nitrogen, Total Phosphorous, Total Potassium and presence of pathogens;
adjusting the wash water tank fluid to an acceptable value by blending additional fluid from solids/liquid separator;

5. The method of claim 1, further comprising: sampling of the wash water tank fluid for COD, Total Nitrogen, Total Phosphorous, Total Potassium and the presence of pathogens;
adjusting the wash water tank fluid to an acceptable value by blending in additional materials such as, but not limited to, nutrients, vitamins, minerals, essential and non-essential amino acids as deemed necessary to promote and attain the desired growth profile for plants and added microbiology.

6. The method of claim 1, including the step of purifying said wash water tank fluid by pasteurization, wherein said fluid is flash heated to between 145-185 degrees Fahrenheit (F) for less than minute before being immediately cooled in heat recovery unit to less than 100 degrees Fahrenheit.

7. The method of claim 1, wherein the pasteurized wash water is placed into aseptic storage containers.
